(19) United States
(12) Patent Application Publication
(10) Pub. No.: US 2026/0172799 A1
(43) Pub. Date: Jun. 18, 2026

(54) SYSTEMS AND METHODS FOR MANAGING SHORT RANGE WIRELESS CONNECTION SESSIONS AND DEVICE CONTROL

(71) Applicant: Sony Interactive Entertainment INC., Tokyo (JP)

(72) Inventor: Warren Benedetto, Lake Forest, CA (US)

(73) Assignee: Sony Interactive Entertainment INC., Tokyo (JP)

(21) Appl. No.: 18/986,607

(22) Filed: Dec. 18, 2024

(51) Int. Cl. H04W 4/80; H04W 64/00; H04W 76/10

(52) U.S. Cl. CPC H04W 4/80; H04W 64/00; H04W 76/10

(57) ABSTRACT

System, process, and device configurations are provided for managing short range wireless data connections by a control device for one or more user devices. A method can include detecting a connection session between a first user device and a first source device, determining a location of the first user device with the first source device, tracking a location update of the first user device, and controlling exchange of the connection session to the second source device in response to the location update. Embodiments can include detecting and using patterns of use and connection history for activating one or more connection source devices. Embodiments also include controlling connections based on source device type and detection of location updates. Control of connections can include detecting source device type and power levels for identification and exchange of connections.

### FIELD

The present disclosure is directed to systems and methods for maintaining connectivity across devices including managing short range wireless data connections, communications sessions, digital audio sessions and interactive entertainment control, electronic game control, user interface operations, gaming device operations, gaming device processes and application functions for connected devices.

### BACKGROUND

Output of digital content to users for viewing and listening may come in in multiple forms. Users often employ multiple electronic devices for digital media and applications. Users may also consume content in multiple locations. As device configurations shift toward wireless output, wired output terminals are eliminated on many devices. As a result there is a need for management of connections and to address user needs. Existing configurations are subject to service interruptions or broken connections when wireless devices are moved out of range. There exists a need for improving device configurations and systems for short range wireless connectivity, and in particular managing short range wireless data connections.

While existing devices and applications allow for connection of a device to an output device, the existing solutions are often inconvenient and disruptive for many uses. Many user habits include movement relative to many locations in one day. Often these movements disconnect short range wireless connection sessions. Moreover, some network applications require device connections to be in a perpetually on or available state which can drain power resources. As such, there exists a need for systems and methods to allow for managing short range wireless data connections.

### BRIEF SUMMARY OF THE EMBODIMENTS

Disclosed and described herein are systems, methods and device configurations for managing short range wireless data connections. In one embodiment, a method includes detecting, by a control device, a connection session between a first user device and a first source device, wherein the connection session includes exchange of data relative to the first user device and the first source device for the connection session. The method also includes determining, by the control device, a location of the first user device with the first source device and tracking, by the control device, a location update of the first user device relative to location of the first source device, wherein the location update is a change in position away from the location of the first source device. The method also includes controlling, by the control device, a communication to a second source device to initiate connection of the second source device to the first user device based on the location update. The method also includes controlling, by the device, exchange of the connection session to the second source device in response to the location update.

In one embodiment, the first user device is a wearable device configured to communicate one or more of audio data, video data, and data in general relative to the first user device and the first source device during the connection session, and wherein the first source device and the second source device are each stationary devices.

In one embodiment, the detecting a connection session includes receiving, by the control device, session information from the first source device, and wherein the session information identifies an application service of the connection session.

In one embodiment, determining a location of the first user device includes identification of a location of the first source device based on at least one prior connection of the first user device and wherein the control device is configured to identify at least one second device based on connection history of first user device.

In one embodiment, tracking the location update of the first user device includes receiving from the first source device a position estimate of the first user device generated by the first user device.

In one embodiment, controlling a communication to the second source device includes identifying at least one additional source device based on one or more of connection history of the first user device and the location update.

In one embodiment, controlling exchange of the communication session includes handoff of the connection session to the second source device, the second source device continuing exchange of data of the connection session with the first user device.

In one embodiment, the method also includes generating a pattern of use for the first user device based on connections of the first user device to one or more source devices.

In one embodiment, controlling exchange of the connection session to the second source device includes determining at least one power level of a source device, and selection of a source device based on determined power level.

In one embodiment, the method also includes controlling connection of the first user device to a second user device prior to controlling exchange of the connection session to the second source device, wherein the first user device is connected to the second user device for the connection session for at least a predetermined period of time.

Another embodiment is directed to a device configured for managing short range wireless data connections for one or more user devices. The device includes a communication interface, a memory storing executable instructions, and a controller coupled to the communication interface and the memory. The controller is configured to detect a connection session between a first user device and a first source device, wherein the connection session includes exchange of data relative to the first user device and the first source device for the connection session. The controller is also configured to determine a location of the first user device with the first source device and track a location update of the first user device relative to location of the first source device, wherein the location update is a change in position away from the location of the first source device. The controller is also configured to control, using the communication interface, a communication to a second source device to initiate connection of the second source device to the first user device based on the location update. The controller is also configured to control, using the communication interface, exchange of the connection session to the second source device in response to the location update.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1A is a graphical representation of a system and device configurations according to one or more embodiments;

FIG. 1B is a graphical representation of user and source devices according to one or more embodiments;

FIG. 1C is a graphical representation of managing short range wireless data connections according to one or more embodiments;

FIG. 2 illustrates a process for managing short range wireless data connections according to one or more embodiments;

FIG. 3 illustrates a graphical representation of a device configuration according to one or more embodiments;

FIG. 4 illustrates a process for managing short range wireless data connections according to one or more embodiments; and

FIG. 5 illustrates a graphical representation of a learning model for control of device connectivity according to one or more embodiments.

### DETAILED DESCRIPTION OF THE EXEMPLARY EMBODIMENTS

### Overview and Terminology

One aspect of the disclosure is directed to managing short range wireless connections. Embodiments include systems, device configurations and methods for detecting device connections, and managing connections and communication sessions of applications across one or more devices and environments for users. Embodiments allow for maintaining a short range wireless connection for a user even with movement of the user out of range of a source device. Embodiments allow for tracking device capabilities and device status for handling a communication session. Systems and processes described herein may be for digital applications and for output of digital content and media including audio, video, voice, network data, and interactive data output, such as gaming, for a user. Systems and processes many include control of device short range wireless communication settings by one or more control devices, such as an interactive entertainment device, media player, gaming console, virtual reality device, network device and electronic devices in general. Connection sessions may be managed and maintained for one or more source devices and one or more user devices, such as wearable user devices (e.g., headset, ear worn speakers, etc.). Embodiments provide operations for detection of devices associated with a user and detection of user connection sessions.

System, process, and device configurations are provided for managing short range wireless data connections by a control device for one or more user devices. Methods can include detecting a connection session between a first user device and a first source device and determining a location of the first user device with the first source device. Connection sessions as discussed herein may include one or more short range wireless communication sessions for exchange of digital data, including but not limited to short range wireless communication standards according to IEEE 802.15 (e.g., Bluetooth™), WiFi direct, Zigbee, Z-wave and short range communication protocols in general. Embodiments may be configured to operate in one or more frequency bands, such as below 1 GHz, between 2.402 and 2.480 GHz or 2.400 and 2.4835 GHz. Embodiments can include detecting and using patterns of use and connection history for activating one or more connection source devices. Embodiments also include controlling connections based on source device type and detection of location updates. Control of connections can include detecting source device type and power levels for identification and exchange of connections. Short range wireless communication may relate to devices with connection ranges of up to 30 feet, that is ranging from 0-30 ft. However, it should be appreciated that short range wireless communication may include ranges limited to values lower than 30 feet including but not limited to 10, 15 and 20 feet.

Embodiments provide solutions to product designs and configurations which are configured for wireless communication and for devices that do not allow for hardwired connection. Digital audio content, for example, is often consumed via a wireless user device (e.g., Bluetooth™ earbuds, headphones, or other wearable devices). Many modern devices, such as smartphones and laptops, have almost entirely done away with 3.5 mm headphone jacks, further pushing adoption of wireless companion devices. As a result, many users spend a significant amount of time using wireless devices, either for listening to audio/video content, for communicating via voice, work, meetings, and entertainment. Embodiments are described herein as using or being applied to earbuds and in some cases Bluetooth™ devices. It should be appreciated that the embodiments are not limited to earbuds and are not limited to Bluetooth™ communication protocols. Embodiments may apply to any portable or wearable device.

Embodiments provide solutions to cross-device connection sessions. Some wireless devices are provide users with freedom of mobility while wearing them. While this may not pose a problem of range when the wireless device is connected to the mobile device, such as a smartphone in a user's pocket, however stationary devices such as a desktop PC or a gaming console may not support a user moving out of range of the device - some wireless protocols have a range of about 30 feet. Once the user moves out of range, the short range connection may be lost with existing configurations. As a result, a user may be disconnected from a connection session. Embodiments provide solutions for seamless cross-device audio and voice chat experiences. Although examples are discussed herein for voice chat conversations with other users, it should be appreciated that embodiments may apply to data presented as part of other applications including gaming, augmented reality, virtual reality, communication channels in general and media output. Embodiments may be applied to applications and/or features of applications on one or more of a gaming console, desktop PC, smartphone, mobile device, tablet, peripheral device, etc.

An example of a problem that may be solved includes a user using an application on their gaming console. In the middle of use of an application, say for example a voice chat application, the user needs to step away from the gaming console to do something in another location, such as a garage. With conventional configurations as the user moves out of range of the gaming console, the user's earbuds will disconnect and the user will disappear from the voice chat conversation. Conventional configurations will disconnect the user and possibly end the session which can be inconvenient and disruptive.

According to embodiments, processes and device configurations are provide for maintaining near-continuous session connectivity, such as audio or communication sessions, as a user moves relative to one or more different devices. The connection session may be maintained or established with one or more user devices, such as wearable headsets, ear buds, headphones, etc. By way of example, embodiments allow for maintaining connectivity among different devices. Take for example a use case for a user is near a stationary device like a desktop PC or gaming console and earbuds connected to the stationary device. According to embodiments, as the user moves out of range of the stationary device, a short range connection, (e.g., Bluetooth™ connection, short range connection in general, etc.) may be seamlessly and automatically transferred to a mobile device. If the user moves within range of another stationary device, the short range connection will be seamlessly and automatically transferred to other stationary device. By maintaining the connection session, the user does not need to disconnect and reconnect devices to the short range session for different devices and is able to enjoy uninterrupted connection to their voice chat. An effect of this system is that the user is always connected to a connection session for one or more applications when the connection session is maintained. In the case of a voice chat application, the user can continue talking with friends without ever thinking about which device an output device (e.g., earbuds) are connected to, and without missing out on any part of the chat. Applications for voice and/or chat is referred to as an example, but principles of the example may be applied to any other digital and audio content, including podcasts, concerts, lectures, etc.

In addition to managing connection based on range or position of a user, embodiments are provided for identifying and controlling devices for detection. Embodiments are also provided for learning and anticipating device connection based on user patterns and device usage. Embodiments provide operations and device configurations that may be incorporated with interactive entertainment devices, media players and game consoles with features that allow for control of device connections and ability to allow for a connection. An additional benefit of identifying devices and maintaining connections may be to enhance user experience of devices. Embodiments include operations and device configurations that can include determining models and updating models for user actions. According to embodiments, operations and device configurations can include detecting user devices, user device parameters and managing connections based on devices and device characteristics.

According to embodiments, systems and processes described herein may be configured to provide one or more features for predictive destination of a user. According to embodiments, predictive destination may include controlling one or more devices short range wireless connection availability based on one or more previous connections of a user. By way of example, based on user history of connecting to devices during similar intervals (e.g., time of day, etc.) and/or location (e.g., home, room, work, vehicle, commercial center, etc.), a control device may activate one or more source devices to maintain a connection session.

According to embodiments, systems and processes described herein may be configured to provide one or more features for dwell time of a user. In order to avoid unnecessary switching between devices, embodiments may incorporate operations for dwell time or the period that a user is associated with a location. Operations may include detecting one or more parameters to determine if a user is located in a particular location and/or near a source device for a particular time and manage connection of the device to the source device based on the amount of time a user has been in the location.

According to embodiments, systems and processes described herein may be configured to provide one or more features for predictive power on. Predictive power on may include one or more operations to allow for a source device to be powered on based on the user direction of travel and/or patterns of behavior. According to embodiments, systems and processes described herein may be configured to provide one or more features for power conservation. While it may be possible for users to be connected to a mobile device at all times, rendering location irrelevant, the connection to a mobile device may unnecessarily drain power resources of the mobile device. Power conservation functions may be performed to connect a user device to a source device that is connected to a power supply or electrical outlet and to preserve power of the mobile device.

Embodiments may be performed for devices outputting and/or presenting digital media and one or more application services directed to communication, voice and video chat, augmented reality, electronic gaming (e.g., video games), digital audio services and media applications in general. Operations and processes may be performed in connection with electronic games and directed to gaming systems, such as consoles, processors or servers that generate game media and interactive entertainment devices. Users of electronic devices (e.g., players, gamers, etc.) may operate devices for extended periods of time and for a variety of applications. Embodiments include management of connections for gaming and non-gaming activities including interactive entertainment control, electronic game control, user interface operations, gaming device operations, and gaming device processes.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### Exemplary Embodiments

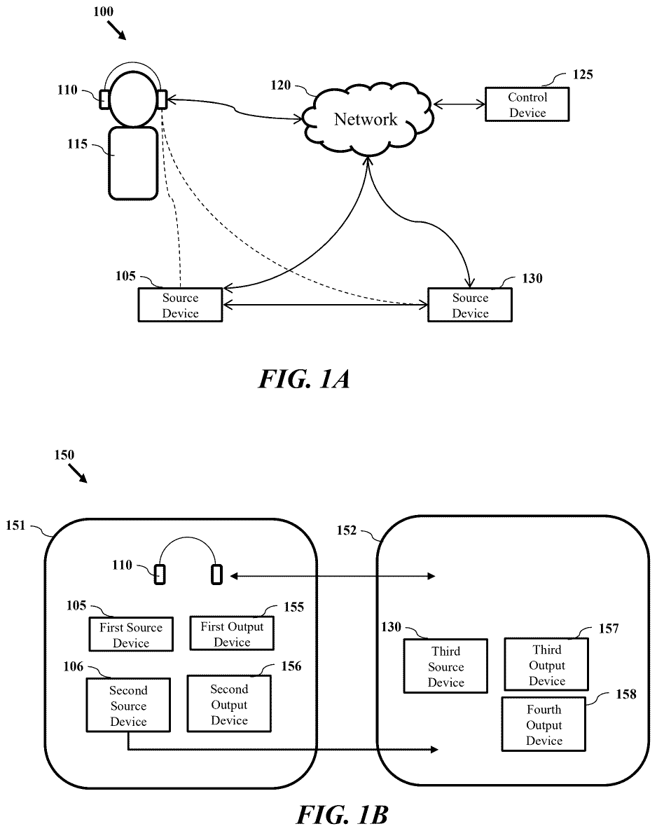

FIG. 1A is a graphical representation of a system and device configurations according to one or more embodiments. FIG. 1 illustrates an exemplary system 100 including source device 105 (e.g., first source device) and user device 110 for user 115. According to embodiments, source device 105 may be configured to output media including audio, video, communication, media, and/or application data user device 110. According to an exemplary embodiment, user device 110 may be a wearable device, such as headphones, ear buds, a headset, electronic wearable including audio and video, and an electronic device in general. System 100 may be configured for one or more processes to manage short range wireless data connections for one or more source devices and user device 110. According to embodiments, devices may be configured for management of connections. System 100 may be configured to operate relative to network 120 (e.g., internet, WiFi, network, etc.) and include control device 125 configured to manage one or more connections by way of network 120. According to other embodiments, control device 125 and its functions may be performed by one or more source devices. In some embodiments, control device 125 may be a network device providing one or more network operations, such as a backend server. According to other embodiments, control device 125 may be local to one or more devices of system 100. User 115 is shown as an example, it should be appreciated that system 100 may operate for a plurality of users.

According to embodiments, system 100 may be configured to manage connections based on one or more parameters to allow for connection sessions for data to be provided from one or more source devices to user device 110. Although user 115 is illustrated with a single user device 110, it may be appreciated that connections may be managed for multiple devices of user 115.

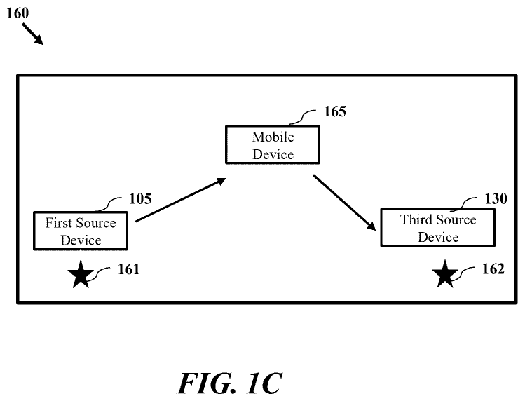

According to embodiments, system 100 and control device 125 may be configured to manage short range wireless data connections for one or more user devices, such as user device 110. Control device 125 may perform one or more processes described herein, including but not limited to process 200 of FIG. 2. According to an exemplary embodiment, control device 125 may manage device connections to allow for maintaining a connection session for user 115. By way of example, control device 125 may detect a connection session between user device 110 and source device 105. Source device 105 may be providing audio, video, and/or media data to user device 110, as such the connection session includes exchange of data. Source devices 105 and 130 may be stationary or mobile devices. Location changes of user 115, and/or one or more other parameters discussed herein, may require control or exchange of the connection session from source 105 as the source of data to source device 130. According to embodiments, system 100 may determine a location of user device 110 with respect to source device 105. System 100 and control device 125 may be configured to detect and track location of user device 110 relative to the location of source device 105. When the location of user device 110 results in a change in position away from the location of source device 105, control device 125 may be configured to control exchange of a connection session to source device 130. Embodiments described herein provide operations to exchange a connection session based on location, position changes and/or movement of user 115. Embodiments also provide exchange of a connection session based on one or more of a predicative destination, dwell time, predictive power and power conservation. System 100 is shown in FIG. 1A with user 115 in a first position and source devices 105 and 130 in one or more locations. Source devices 105 and 130 may each be stationary, such as one or more of a smart TV, game console, and personal computer. According to other embodiments, source device 105 may be stationary and source device 130 may be a mobile device. According to other embodiments, source devices 105 and 130 may each be mobile, such as a laptop and a mobile phone, respectively. Mobile device types may include laptops, smart phones, mobile device, tablets, etc. As shown in FIG. 1A, user device 110 may be in electrical communication with one or more of source devices 105 and 130, and connection status may include one or more if a single connection (e.g., connection to only one device at a time), and multiple connections (e.g., connection to multiple devices at a time). Some short range wireless communication protocols only allow for user devices, such as user device to receive source content form one device at a time. Embodiments may be applied to user devices and wearables allowing for single connections and multiple connections over a short range wireless connection session.

According to embodiments, system 100 and embodiments described herein are directed to maintaining and automatically transferring wireless connections between devices. System 100 may be configured to detect wireless connections between two or more devices, such as source device 105 and user device 110. Physical location of devices may be detected using global positioning data (e.g., GPS) or other positioning technology. According to other embodiments, position may be detected based on short range wireless communication. System 100 and/or control device 125 may detect and use location data to determine the distance between devices, as well as movement data. When system 100 detects user 115 is moving away from a stationary connected device, such as source device 105, an automatic connection may be made to another source device, such as source device 130, which may be a mobile device or a device at the next location. By providing an exchange of the connection session, the connection session may be maintained and user 115 may continue to receive content undisturbed. Embodiments provide operations for exchange of the session, identification of devices for the session and even maintaining a session based on power levels of devices. Control device 125 may be configured to record and store patterns of user behavior and use the data to identify one or more source devices a user is likely to be near or available for use. Using either the movement data or the historical user behavior, control device 125 can activate devices in a low power state to facilitate the connection transfer. Control device 125 can prioritize connections to electrical powered devices over battery operated devices in order to conserve power. Control device 125 can require a user device to be in range of a stationary device from a set period of time before switching the connection from a mobile device.

User device 110 is shown in FIG. 1A as a wearable device. User devices may include head worn devices, such as head mounted units, virtual reality goggles and immersive experiences and may detect user motion and control device operation, such as views of a game or experience. By way of example, connection sessions for an augmented reality session may include a wearable as user device 110 having short range communication and processing capabilities in addition to output of digital audio, such as video data presentation, imaging, sensing, and the ability to receive and communicate user controls. User device 110 and user devices as referred to herein may be output devices, such as wireless output devices, and/or devices configured to provide one or more communication and functional outputs. Embodiments and principles discussed herein may apply to smart devices and/or devices with directed functionality such as wireless ear buds for audio output.

According to embodiments, system 100 and control device 125 may be configured to provide one or more features for predictive destination of user 115. According to embodiments, predictive destination may include control device 125 controlling one or more devices, such as source devices 105 and 130, short range wireless connection availability based on one or more previous connections of user device 110. By way of example, based on user history of connecting to user device 110 during similar intervals (e.g., time of day, etc.) and/or location (e.g., home, room, work, vehicle, commercial center, etc.), control device 125 may activate one or more of source devices 105 and 130 to establish or maintain a connection session.

According to embodiments, system 100 and control device 125 may be configured to perform one or more operations for predictive destination, such as estimating user destination based on one or more of user location, user movement and previous user connections. Predictive destination operations may include aggregating user movement and/or connections. As data about the user's movement is aggregated, system 100 can begin to predict where the user is most likely heading, how long they will be there, and where they may go next. According to embodiments, prediction as used herein includes estimations by one or more of system 100 and control device 125 based on a set of connections and possible connections. Connections may be stored in memory for access following detection of one or more user and source devices. Predictive destination operations may allow system 100 to more accurately transfer the short range wireless connections to an available or correct device. As an example, a user may typically sit in a home office from 9 AM to 5 PM, with wireless earbuds connected to a desktop PC. At 5 PM, the user typically leaves home to go pick up dinner at a local restaurant. At 7 PM, the user typically goes into the family room and plays games on the gaming console until 10 PM. At 10 PM, the user goes to the bedroom and watches TV until bedtime. Using this typical pattern of behavior, system 100 can make smart decisions about which device the earbuds should be connected. At 9 AM, system 100 may automatically connect the earbuds to the desktop PC as soon as the user puts them on. At 5 PM, system 100 may proactively transfer the connection to the user's smartphone, because the user will be leaving the house to get dinner. At 7 PM, system 100 may connect the earbuds to the gaming console, even though the desktop PC and bedroom TV may also be in range. At 10 PM, the earbuds may transfer to the bedroom TV until the user removes them at bedtime.

According to embodiments, system 100 and control device 125 may make estimations or predictions based on user direction of travel. For example, if the user leaves the living room and makes a right turn in the direction of the bedroom, system 100 may proactively transfer the connection to the bedroom TV. On the other hand, if the user makes a left turn in the direction of the home office, system 100 may proactively transfer the connection to the desktop PC in the office instead. It should be appreciated that embodiments of system 100 and control device 125 are not limited to a user's home. System 100 and control device 125 may make predictions about the user being connected to the bedroom TV in the morning, in the car during a commute to work, to the office PC during the work day, in the car during the commute back home, and then on the gaming console in the evening.

According to embodiments, system 100 and control device 125 may be configured to provide one or more features for dwell time of a user. In order to avoid unnecessary switching between user device 110 and a source device, embodiments may incorporate operations for dwell time. Operations may include detecting one or more parameters to determine if user device 110 and/or user 115 is located in a particular location and/or near a source device for a particular time and manage connection of user device 110 to a source device based on the amount of time a user has been in the location.

According to embodiments, system 100 and control device 125 may be configured to perform one or more operations to avoid unnecessary switching between mobile and stationary devices, control device 125 may incorporate the concept of dwell time. When connected to a mobile device, a user device may remain connected to that device for a period of time even after the user has come within range of a stationary device. Once the user has dwelled in range of the stationary device for a sufficient period of time without any indication of moving out of range, the user device can determine the user is likely to stay in range and can transfer the connection to the stationary device. For example, for a user device connected to a gaming console in the living room, if the user quickly walks into the home office to grab a pen, before returning to the living room system 100 may not transfer the connection to another source device. Even though the desktop PC is in the home office, the system doesn't transfer the Bluetooth connection there, because the user hasn't dwelled in its proximity for long enough. However, if the user was to sit down in the office to write a letter, then the system would detect that the user is dwelling within range of the desktop PC for long enough, and would transfer the connection to the PC after enough time has elapsed. Dwell time operations may be in conflict with the predictive destination embodiment. For example, system and device configurations may be configured to determine if a system should proactively transfer to the home office when the user heads in that direction, or if it should wait until the user has dwelled there long enough. This conflict could be resolved as a setting of an application or control device 125 to predictively transfer or wait for a predetermined period of time before transferring. In some cases, the two systems could be combined. If control device 125 knows that the user typically moves from the living room to the bedroom at 10 PM, and the user is heading in that direction at that time, then the system can transfer the connection without waiting for the dwell time. If the user heads to the bedroom at an unlikely time, control device 125 can wait for the user to dwell there before transferring the connection.

According to embodiments, system 100 and control device 125 may be configured to provide one or more features for predictive power on. Predictive power on may include one or more operations to allow for a source device, such as source devices 105 and 130, to be powered on based on the user direction of travel and/or patterns of behavior. According to embodiments, systems and processes described herein may be configured to provide one or more features for power conservation. Power conservation functions may be performed to connect user device 110 to a source device that is connected to a power supply or electrical outlet and to preserve power of mobile device.

According to embodiments, system 100 and control device 125 may be configured to perform one or more operations for predictive power on. Not every device to which the user may connect will be powered on at all times. With predictive destination, control device 125 could predictively power on devices based on the user's direction and speed of travel, and/or their patterns of behavior. This may require devices to have some sort of “rest mode” or “low power mode” where it is still able to receive remote commands while consuming minimal energy. For example, control device 125 could power on the bedroom TV at a determined time, such as 9:58 PM, knowing that the user will likely be heading to the bedroom at 10 PM. This would ensure that the device is fully ready and able to receive the Bluetooth connection when the user is in range.

According to embodiments, system 100 and control device 125 may be configured to provide one or more operations for power conservation. While there may be a desire to connect wireless devices exclusively to a mobile device such as a smartphone at all times to make location irrelevant—the user can just go anywhere at any time and always stay connected, the reality is devices have limited battery life. Stationary devices are usually connected to an electrical source, such as a power outlet. Connecting to a stationary device when available for a connection session can conserve battery on the mobile device. Control device 125 may take the battery level of the connected devices into consideration when determining which device should be sent the Bluetooth connection. Examples of control parameters a control device 125 may use include determining if the user is in range of a device which is connected to electrical power, then the connection would be sent to that device, to avoid unnecessarily draining power from a battery-powered device. If there is only a choice of multiple battery-powered devices (e.g. a smartphone and a laptop), then the system would send the connection to the device with the most remaining battery charge. If there is a choice of multiple devices connected to electrical outlets, then the system could choose to connect to the one which consumes the least electricity. For example, don't connect to the power-hungry gaming PC when the lower-power device next to it is available as well.

According to embodiments, managing exchange of a connection may require that each device or source device of system 100 includes an application and/or application programming interface to host and output data of the connection session. When data of the connection session is audio data, for example, the user output device may include one or more speakers to receive and output the sound data to the user. Source devices may include one or more of a processor, input/output interface and/or communication interface to provide data either stored by the device and/or received by way of a network connection to the user device. For network data, one or more source devices of system 100 may communicate with control device 125 to exchange a session between one device and another. Exchange of the session may include exchange of the application and application communication resources to the second source device. As such multiple instances of an application may be operating to allow for exchange of a current state and control configuration of an application to another instance of the application, or application including similar control features, on a second source device. According to embodiments, exchange of a connection session may include communication of one or more of the source of the content, application of the connection session, user identification/account, time stamp/playback information of content, communication resources/channels of a communication session and identification of parties to a connection session. Connection sessions may apply to one or more device application and network application features for content and/or communication, the parameters and information provided for the exchange may be determined by control device 125 and based on source device capabilities.

FIG. 1B is a graphical representation of user and source devices according to one or more embodiments. According to embodiments, managing short range wireless data connections may be performed for system 150 including a plurality of devices in a plurality of locations. FIG. 1B illustrates location 151 including first source device 105 and user device 110. Location 151 may also include second source device 106, first output device 155 and second output device 156. Location 152 may relate to a second location, and includes third source device 130, third output device 157 and fourth output device 158. Locations may be physical locations, such as a home or street address. Locations may refer to portions or sections of a particular fixed location such as a room or area of a home or portion of an address. System 150 may store and track locations that may be virtual or collections of devices associated to a virtual location. As such, a work place or location in a work place may be considered a location. Physical locations as discussed herein may include one or more additional locations or sub-locations. For example, a user's home may include multiple locations associated with a physical address. Alternatively, locations may be relative to source devices and user device connection sessions, such that once a user device is nearing range of a source device, a second location may be determined and/or identified based on devices able to maintain a connection session.

According to embodiments, based on a user moving from a first location, such as location 151, to a second location, such as location 152, a connection session may be exchanged from a first source device to a second source device. FIG. 1B illustrates user device 110 moving from location 151 to location 152. According to embodiments, a location update of a user may be detected based on the user physically moving from location 151 to location 152. According to some embodiments, locations 151 and 152 are close enough to allow for user device 110 to detect and maintain the session with a source device in location 152. According to other embodiments, a mobile device (e.g., mobile phone, tablet, etc.), such as second device 106 may act as an intermediary to maintain the connection session when user device 110 is not in range of source devices in location 151 and location 152. Second source device 106 is shown as moving with a directional arrow towards location 152. According to embodiments, a connection session may be exchanged from a stationary device to an intermediary device, such as a mobile device. FIG. 1C illustrates use of an intermediary device.

According to embodiments, devices associated with a location may be determined based on connections to other devices. For example, user device 110 may alert first source device of its presence, or put another way, first source device 105 may detect the presence of user device 110 based on the ability to connect to short range capabilities of user device 110. Devices using short range wireless communication can announce or output periodic communications (e.g., pings) to announce their presence. These communications can be detected by devices. In addition, devices may be configured to communicate detected pings from devices to a control device, such as control device 125. When source devices act as a control device, source devices may detect one or more pings for any device associated with a user. As such, first source device 105 may provide media, data or communication to user device 110 and receive connection availability of any of the devices of location 151 and location 152, including but not limited to pings detected by third source device 130. Devices may share pings and device connections to a network device or network service storing device information. By way of example, control device 125 may store an identification of each device associated with locations 151 and 152. In addition, location information for devices may be assigned or determined based on location information shared with the control device. Many mobile devices have location services and can share location, such as physical location, address, global position data and virtual location to control device 125. Based on the pings received by a mobile device for one or more locations, the mobile device can share pings for each location and ping timing. As such control device may include an identification of devices and device location. Devices can also share location information which can include network address, physical location and/or a user assigned location which can be received by control device 125.

According to embodiments, short range wireless connection activity may be tracked to update and provide recent location of devices. Control device 125 may be configured to determine that a device is not available if communications are not received by other devices at a location. For example, determining that short range communication signals or pings have not been received for a predetermined period of time may include that a device is no longer available or that a user with a wearable device is moving. For example, a user wearing user device 110 may move such that first source device 105 does not receive or is about to lose connection with user device 110 while control device can detect that second source device 106 receives short range communication ability with user device 110. Control device 125 may detect that second source device 106 is moving based on location or positions data provided by second source device 106. In one embodiment, a connection to a mobile device may persist while connection to other devices may be lost. Detection of short range communication from one or more additional devices, such as third source device 130 in location 152 may indicate that user device 110 has moved. In addition to or separate from the ability to maintain a connection session, control device 125 may also detect power and patterns of movement for controlling exchange of a session.

According to embodiments, connectivity for locations, such as locations 151 and 152 may utilize a cloud-based configuration which includes tracking the physical location of each device to which the user devices are connected, as well as the location of the user device. Location may be determined via one or more global positioning sensors and/or proximity to a device including location services (e.g., GPS, location services, etc.). Based on connectivity for locations, one or more of a spatial position or estimated position of user device 110 may be detected relative to the other devices that may be paired to user device 110. According to embodiments, location/position data of user devices allows the system to determine the distance between the user device and each of the connected devices, as well as movement data for the user device and each connected device including but not limited to direction of movement, speed of travel, etc. Using this data, system 100 can estimate when the user is moving away from a stationary connected device and can proactively connect the user device to a mobile device, or to another stationary device in the user's next location.

FIG. 1C is a graphical representation of managing short range wireless data connections according to one or more embodiments. FIG. 1C also illustrates process 160 when a user device is moving from a first position 161 to a second position 162. Process 160 may be an exemplary representation of exchange of a connection session from first source device to mobile device 165 to a second source device, such as third source device 130. In process 160, mobile device 165 may act as an intermediary device. By way of further example, for a communication session over an application, or which may be part of an electronic game (e.g., game session, etc.), a user on a gaming console may chat with friends. In the event the user leaves the room where the gaming console is located and heads toward a different position, for example the user's garage, process 160 illustrates an exemplary exchange of connection session. FIG. 1C illustrates exchange of a connection session relative to devices maintaining the connection session. As the connection session is exchanged, each device may then maintain or host the communication services to keep the connection session running. Not shown in FIG. 1C is a user device (e.g. user device 110), however each device in FIG. 1C and process 160 may include output of the connection session content to a user device, such as user ear buds or user devices in general. Process 160 may be based on a connection between first source device 105 and a wireless device (e.g., user output device 110). According to embodiments, process 160 can include detecting that a user device (e.g., wireless device, earbuds, etc.) is moving away from first source device 105, which may be a stationary device. Based on a user's direction and speed of travel and/or the user device direction and speed of travel, the system can estimate and/or predict that the user will be out of wireless range within a time period - in an example case, 12 seconds of movement may relate to movement out of range. Using detection of mobile device 165 and possibly a connection or ability to connect mobile device 165 to the user device, process 160 may include exchange of a connection session to mobile device 165. Exchange of the connection session may include sending a message to mobile device 165 including a request and/or instructions to connect to the wireless device and host a connection session. Process 160 may be performed without a user's knowledge. In some instances, process 160 may include providing a notification to the user by way of one or more devices that the connection session has been exchanged. Notifications can include audio, graphical, and/or haptic notifications to a user. Continuing with the example use case, if the user returns to the house from the garage but does not return to the room where the gaming console is located, process 165 may determine a different device for the connection session. For example, if the user returns to a different room where a desktop PC is located, a device located with user location may be determined and used to exchange the connection session. Process 160 can include controlling the transmission and coordination of communication resources with one or more applications including proactively communication with an application on identified devise to maintain the connection session. References to connection session may include generating one or more connections sessions and network resources such that the user experiences a single continuous session or service based on one or more channels, network resources and network sessions being used.

Process 160 may be performed by applications executed on one or more devices, the applications relating to instances of an application on different devices or an application layer that may be included or run by devices. For example, a first application on a first device may be configured for communication of a connection session to a second application on a second device. Alternatively, devices may perform functions that may be a shared application, such that a first instance of a first application on a first device and a second instance of the first application on the second device. Each instance may be code of the application or program resident on a device. The application may be controlled by a control device of each device. Servers, such as control devices may run applications or code to support and provided services of the applications.

According to embodiments, system 100 may be configured for one or more users. While FIG. 1A is illustrated showing user 115, it should be appreciated that embodiments may be applied to multiple users. Operations and processes may be performed on a user with one or more configurations or source and user devices. According to embodiments, control device 125 may be configured to present electronic gaming content from one or more of a gaming console, such as console, or from a network source to one or more devices of system 100. Content presented, such as game content, may have one or more data output feeds.

According to embodiments, systems and configurations described herein may be configured to provide features to improve user experience, wherein functions and operations described herein are performed following user consent with express notice to a user and/or in alignment with one or more user settings and preferences for user privacy. It should be appreciated that embodiments may be applied to interactive entertainment with one or more users. Processes described herein are not limited to gaming content.

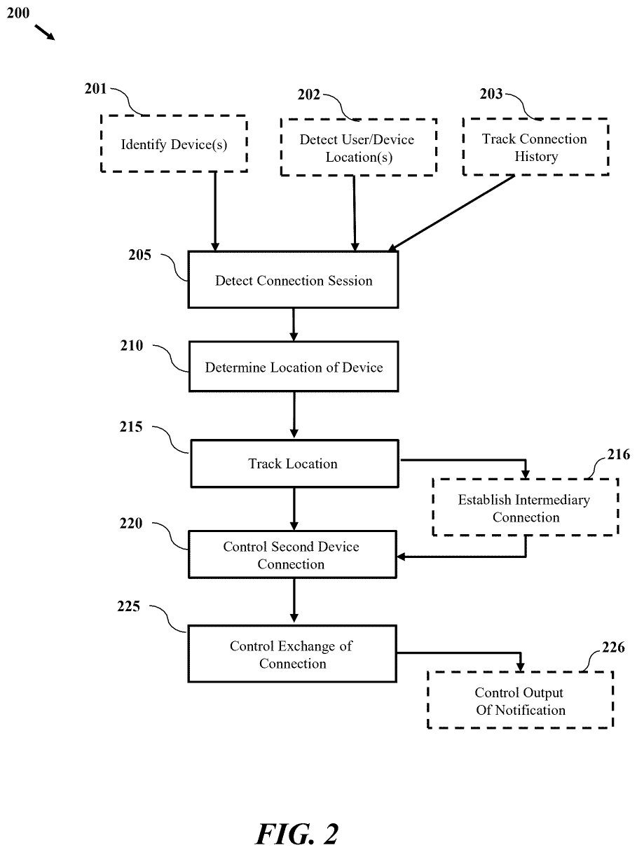

FIG. 2 illustrates a process for managing short range wireless data connections according to one or more embodiments. Process 200 may control devices for supporting and providing a connection session for one or more applications including communication and chat features, audio services, gaming device operations. According to embodiments, process 200 may detect a connection session based on short range wireless connection of devices captured for a user. Connections may be captured for a user across one or more devices and for one or more applications. A user profile may be stored by a control device (e.g., control device 125) including one or more user devices, user accounts, user applications and features for identifying a user, user device, and source device. Process 200 may be performed by a device, such as device 300 and/or controller 310 of FIG. 3, for operations.

According to embodiments, process 200 may be performed by a network device servicing one or more applications resident on user devices. Process 200 may relate to operations performed by an application layer on one or more devices and systems described herein. Process 200 may be initiated by a device (e.g., device 300) detecting a connection session between a first user device and a first source device at block 205. Connection sessions may be detected for a device associated with the source device to at least one user device. During a connection session, a first user device and a first source device may exchange data using/during the connection session. Connections sessions may allow for output of data to the user device beyond data for connecting the device. For example, a connection session may use a protocol to establish a communication channel or link between devices. The connection session may provide data and/or content, such as audio, video, notifications, etc. to the user device beyond the channel itself. For example, a connection session may include voice data, such as two-way voice data for a voice chat, media output such as digital audio, and/or gaming data. User devices, such as the first user device, may be wearable devices configured to communicate one or more of audio data, video data, and data in general relative to the first user device and the first source device during the connection session. According to embodiments, source devices, such as the first source device and the second source device are each stationary devices. Detection of a connection session may include receiving session information from the first source device. A control device may receive a communication and/or transmission from the source devices when user devices are connected. The received communications can include identification of the user device, location of the source device, type of connection session, application used, duration of connection session, time of day, day of week, etc. Session information can identify an application service of the connection session and provide details of the connection session such as media being output, playback information including but not limited to playback details and timestamps of content. Connection sessions may include a connection between a wireless output device and a first source device. Connection sessions may be associated with use of an application and/or as part of an electronic gaming session during one or more periods of a gaming session.

At optional block 201, process 200 includes identifying one or more devices, such as user devices, source devices and mobile devices associated with one or more users. Identification of devices can also include identification of power characteristics and levels of devices. When stationary devices are detected a control device may determine if the devices include a dedicated power source, such as wired power. A control device may also identify device power levels, such as a battery level which may be considered for use of the device to host a connection session. At optional block 202, process 200 includes tracking location of devices and/or locations. Locations detected may be physical, labeled (e.g., named, defined, etc.) by a user and/or virtual. Devices may share location information based on position services. Network addresses may also provide a physical address associated with the network service. Systems and processes may detect one or more labels for devices from a user. For example, a user may label the location of a device such as living room or bedroom. Virtual locations may result to locations that have a moveable or defined location including but not limited to a vehicle/car, office, etc. At optional block 203, process 200 includes tracking connection history. A control device may track devices, connections and connection histories for the user. Determinations at optional blocks 201-203 may provide data with user's connections to allow for connection sessions to be managed.

At block 210, process 200 includes determining a location of the first user device with the first source device. Location determinations may be performed by a control device during the start of a connection session, during a connection and even prior to a connection session. At block 210, the location of a device may be determined based on the detected connection session at block 205. Locations determined at block 210 may be a known location, such as location defined by a user and/or a location new to a user. According to embodiments, determining a location of the first user device includes identification of a location of the first source device based on at least one prior connection of the first user device and wherein the control device is configured to identify at least one second device based on connection history of first user device. When the location is a known location, the known location may be used to define and/or determine range of a short range wireless connection. Process 200 may include generating a pattern of use for the first user device based on connections of the first user device to one or more source devices.

According to embodiments, location updates may be relative to a known list of devices assigned to locations. Multiple locations or environments may be associated with a physical location. For example, a user's home may have different rooms or areas such as a living room, office, basement, bedroom, etc. Locations may be separated by distance and structural elements. In an office setting, for example, the user's work space may be one location and a conference room may be another location. In addition to actual locations, the system may operate for stationary and mobile devices. A user's phone or other device with communication ability may be an intermediary device and act as a source device for one or more defined or undefined locations, the undefined locations being either undetected or related to a user in movement between locations. The intermediary device may allow for handling a connection session at least temporarily.

At block 215, process 200 includes tracking a location update of the first user device relative to location of the first source device. Tracking location may be performed to determine whether a location update is a change in position away from the location of the first source device. Tracking the location update of the first user device may include receiving from the first source device a position estimate of the first user device generated by the first user device. Tracking may be performed to determine changes in physical locations of the wireless output device. Tracking may include detecting a state change or location change of a user. At block 215, a control device may also tracking power levels of devices including determine power source and battery life possible for connected devices.

At optional block 216, process 200 may include establishing intermediary connection to one or more devices. Process 200 may include controlling connection of the first user device to a second user device prior to controlling exchange of the connection session to the second source device. The first user device may be connected to the second user device for the connection session for at least a predetermined period of time.

At block 220, process 200 includes controlling a communication to a second source device to initiate connection of the second source device to the first user device based on the location update. Controlling a communication to the second source device can include identifying at least one additional source device based on one or more of connection history of the first user device and the location update. Controlling at block 220 may include selecting one or more devices available for connection. Selection may be based on predicting next device within range or in use based on user behavior.

At block 225, process 200 includes controlling exchange of the connection session to the second source device in response to the location update. Controlling exchange of the communication session includes handoff of the connection session to the second source device, the second source device continuing exchange of data of the connection session with the first user device. For example, a connection session provided by a first device for audio output may be transferred to a second source device. The short range wireless communication protocol for the connection may be transferred or a new session may be generated, such that the short range wireless communication secession is used and processed to control other devices. A timestamp, playback time or session interval may be used by the second device to maintain the session. Controlling exchange of the connection session to the second source device includes determining at least one power level of a source device, and selection of a source device based on determined power level. At block 225, process 200 includes determining if an output device or source device has been within range for set amount of time. A control device may prompt a source device to activate from a low power state.

At optional block 226, process 200 may control output of notification. Connection session notifications may include control of one or more haptic elements in source devices, mobile devices, user device, game controllers and/or wearables. According to embodiments, the notification can include one or more of an output sound, control of a display, control of lighted elements, presentation of a graphic and vibration of a wearing device.

FIG. 3 illustrates a graphical representation of a device configuration according to one or more embodiments. Device 300 is configured for managing short range wireless data connections and may relate to a gaming console, media device, display device and/or network device. Device 300 may relate to a mobile device and operations of device 300 may be performed by a mobile device as described herein. According to embodiments, device 300 includes communication module 305, controller 310, and memory 315. Device 300 may also include an interface (e.g., input/output (I/O) interface) 320. Device 300 may optionally include an output, such as a display and or haptic element for providing notifications. Device 300 may output gaming content to output 325.

Controller 310 may relate to a processor or control device configured to execute one or more operations (e.g., executable instructions) stored in memory 315, such as processes for managing short range wireless data connections. Memory 315 may be non-transitory memory configured to provide data storage and working memory operations for device 300. Memory 315 may be configured to store computer readable instructions for execution by controller 310 for one or more processes described herein. Communication module 305 may be a communications module configured to receive and transmit network communication data, media, audio data, and image data and gaming content. Device 300 may be configured to receive and output data for a connection session using communication module 305. Device 300 may be configured to receive input from a user using interface 320. According to embodiments, communication module 305 may be configured to provide a connection session and communication with one or more user devices and for receiving instructions from a network device. Controller 310 may be configured to control exchange of a connection session relative to one or more devices. When device 300 is a network control device, exchange of a connection session may be based on one or more devices detected by device 300 and determined for the connection session. When device 300 is a source device, controller 310 may be configured to host and/or exchange a connections session to another device. Device 300 may also be configured to provide media to one or more media devices using communication module 305 and/or interface 320. Device 300 and controller 310 may be configured to perform one or more processes described herein including but not limited to provide a learning module for detection and control of devices for short range communication. Similarly, device 300 and controller 310 may be configured to perform one or more operations for a maintaining a connection session, dwell time operations, a power conservation module, and predictive power on.

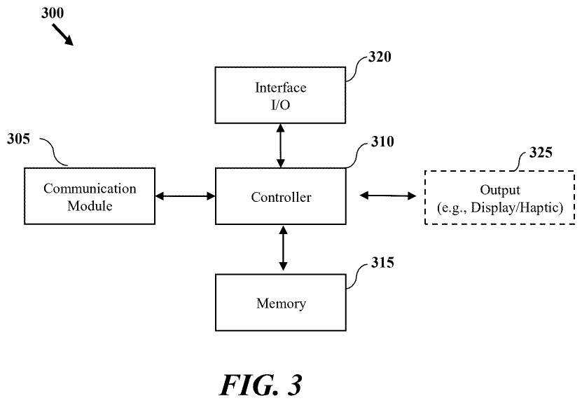

FIG. 4 illustrates a process for managing short range wireless data connections according to one or more embodiments. Embodiments described herein include detecting and estimating one or more of user location, user operations and user connections of devices. Process 400 may allow for identification of devices to maintain and use for connection sessions. FIG. 4 illustrates process 400 which may be performed by one or more of a source device, user device and control device.

Process 400 may include detecting one or more of connection data at block 405 and position data at block 410. Connection data detected at block 405 may include identification of devices used by a user including source devices, user devices and devices associated with a user. Position data at block 410 may include one or more locations, including, physical, labeled and virtual locations associated with a user. At block 415, process 415 may track the habits and patterns of user connections including duration, time of day, day of week, etc.

At block 420, process may generate a schedule of user connections and connection session. The schedule at block 420 may include a pattern of connection history and transition or selections of device for activities and locations. Process 400 may also be used for detecting and control of device connections. Process 400 may optionally include receiving a position update at block 421. Position updates may include determinations of a user location. Position updated may include availability and/or presence of devices in communication with another. Position updates may not be tied to user location. For example, a user may be in a first location using a first source device and a first user device and a position update may be for a second user device or second source device announcing presence to a third source device.

At block 425, a control device may control device power based on one of more of a user position and a schedule. By way of example, a device may be powered up and/or controlled to receive a connection session at block 425. Controlling device power may relate to control of a device power level and/or controlling short range communication resources for the device. At block 430, process 400 may control device connection based to maintain the connection session.

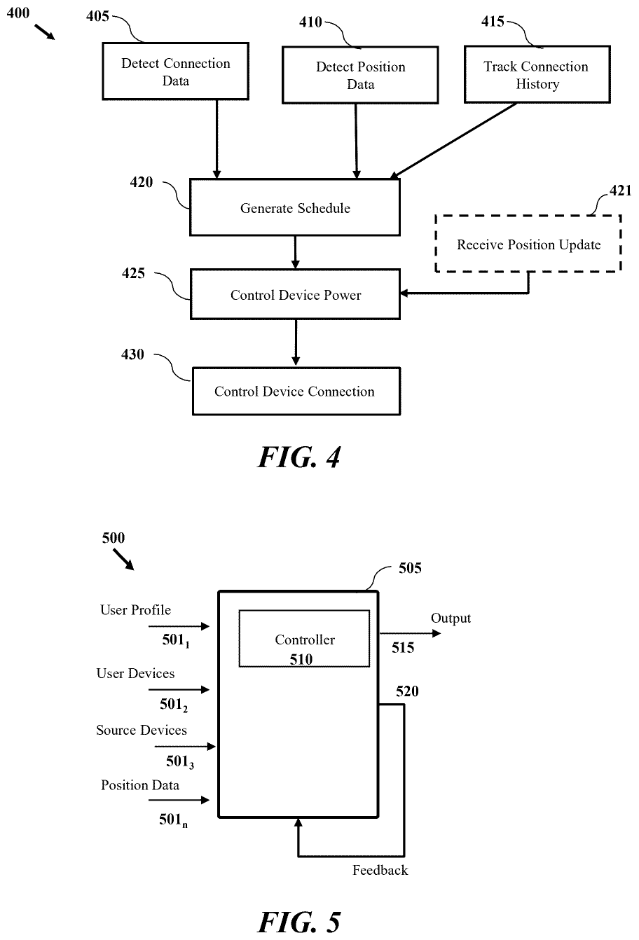

FIG. 5 illustrates a graphical representation of a learning model for control of device connectivity according to one or more embodiments.

Training process 500 can include receiving training parameters 501₁₋ₙ as training input by device 505 including a controller 510. According to embodiments, controller 510 may receive a plurality of forms user, device and location data as training input. Training process 500 may be used to receive user specific variables to train and determine device connections for a specific user or set of users. Training process 500 may be configured to receive general information for users in general to learn connections and configurations for users in general. In embodiments, training parameters 501₁₋ₙ may include user profile data 501₁, user devices data 501₂, source devices data 501₃ and position data 501ₙ. User profile data 501₁ may provide one or more parameters describing user identification, user applications, user connection session types and user data in general. User profile data 501₁ may include input and input fields for devices associated with a user and identification of user locations. User devices data 501₂ may include identification of one or more user devices including type of device, device name (e.g., device or user provided), and device functions. For example, user devices data 501₂ may identify wireless earbuds with one or more of speakers for output of audio, a microphone for detecting audio, range of the ears buds, power level (e.g., charge level) of the ear buds and identification of past connections. Source devices data 501₃ may include one or more source devices including type of device, device name (e.g., device or user provided), and device functions, device location, device being stationary or mobile, and past connections. Source devices data 501₃ may include one or more applications or application program interfaces for communication during a connection session. Position data 501ₙ may include position data of a user, position data for devices and features of one or more locations associated with a user. According to embodiments, position data 501ₙ may provide user dwell time data and patterns associated with one or more positions.

According to embodiments, controller 510 may be configured to generate output 515 based on a recursive loop including training and feedback. Feedback loop 520 may provide information such as ratings and accuracy for output 515.

According to embodiments, training process 500 and controller 510 may be configured to use one or more learning models (e.g., artificial intelligence, iterative models, etc.) to detect and evaluate determination of devices for a connection session, identification of devices and maintaining connection sessions. Training process 500 and controller 510 may use one or more libraries connection sessions and dropped connections as control examples. According to embodiments, output 515 may include output of connection timing and devices based on detection of user location and devices. According to other embodiments, training process 500 and controller 510 may be configured to provide output for one or more of seamless connectivity, predictive destination, dwell time operations, predictive power on and power conservation.

While this disclosure has been particularly shown and described with references to exemplary embodiments thereof, it will be understood by those skilled in the art that various changes in form and details may be made therein without departing from the scope of the claimed embodiments.

What is claimed is:

1. A method for managing short range wireless data connections by a control device for one or more user devices, the method comprising:
detecting, by a control device, a connection session between a first user device and a first source device, wherein the connection session includes exchange of data relative to the first user device and the first source device for the connection session;
determining, by the control device, a location of the first user device with the first source device;
tracking, by the control device, a location update of the first user device relative to location of the first source device, wherein the location update is a change in position away from the location of the first source device;
controlling, by the control device, a communication to a second source device to initiate connection of the second source device to the first user device based on the location update; and
controlling, by the device, exchange of the connection session to the second source device in response to the location update.

2. The method of claim 1, wherein the first user device is a wearable device configured to communicate one or more of audio data, video data, and data in general relative to the first user device and the first source device during the connection session, and wherein the first source device and the second source device are each stationary devices.

3. The method of claim 1, wherein the detecting a connection session includes receiving, by the control device, session information from the first source device, and wherein the session information identifies an application service of the connection session.

4. The method of claim 1, wherein determining a location of the first user device includes identification of a location of the first source device based on at least one prior connection of the first user device and wherein the control device is configured to identify at least one second device based on connection history of first user device.

5. The method of claim 1, wherein tracking the location update of the first user device includes receiving from the first source device a position estimate of the first user device generated by the first user device.

6. The method of claim 1, wherein controlling a communication to the second source device includes identifying at least one additional source device based on one or more of connection history of the first user device and the location update.

7. The method of claim 1, wherein controlling exchange of the communication session includes handoff of the connection session to the second source device, the second source device continuing exchange of data of the connection session with the first user device.

8. The method of claim 1, further comprising generating a pattern of use for the first user device based on connections of the first user device to one or more source devices.

9. The method of claim 1, wherein controlling exchange of the connection session to the second source device includes determining at least one power level of a source device, and selection of a source device based on determined power level.

10. The method of claim 1, further comprising controlling connection of the first user device to a second user device prior to controlling exchange of the connection session to the second source device, wherein the first user device is connected to the second user device for the connection session for at least a predetermined period of time.

11. A device configured for managing short range wireless data connections for one or more user devices, the device comprising:
a communication interface;
a memory storing executable instructions; and
a controller coupled to the communication interface and the memory, wherein the controller is configured to
detect a connection session between a first user device and a first source device, wherein the connection session includes exchange of data relative to the first user device and the first source device for the connection session;
determine a location of the first user device with the first source device;
track a location update of the first user device relative to location of the first source device, wherein the location update is a change in position away from the location of the first source device;
control, using the communication interface, a communication to a second source device to initiate connection of the second source device to the first user device based on the location update; and
control, using the communication interface, exchange of the connection session to the second source device in response to the location update.

12. The device of claim 11, wherein the first user device is a wearable device configured to communicate one or more of audio data, video data, and data in general relative to the first user device and the first source device during the connection session, and wherein the first source device and the second source device are each stationary devices.

13. The device of claim 11, wherein the detecting a connection session includes receiving, by the control device, session information from the first source device, and wherein the session information identifies an application service of the connection session.

14. The device of claim 11, wherein determining a location of the first user device includes identification of a location of the first source device based on at least one prior connection of the first user device and wherein the control device is configured to identify at least one second device based on connection history of first user device.

15. The device of claim 11, wherein tracking the location update of the first user device includes receiving from the first source device a position estimate of the first user device generated by the first user device.

16. The device of claim 11, wherein controlling a communication to the second source device includes identifying at least one additional source device based on one or more of connection history of the first user device and the location update.

17. The device of claim 11, wherein controlling exchange of the communication session includes handoff of the connection session to the second source device, the second source device continuing exchange of data of the connection session with the first user device.

18. The device of claim 11, further comprising generating a pattern of use for the first user device based on connections of the first user device to one or more source devices.

19. The device of claim 11, wherein controlling exchange of the connection session to the second source device includes determining at least one power level of a source device, and selection of a source device based on determined power level.

20. The device of claim 11, further comprising controlling connection of the first user device to a second user device prior to controlling exchange of the connection session to the second source device, wherein the first user device is connected to the second user device for the connection session for at least a predetermined period of time.
